(19) United States
(12) Patent Application Publication
(10) Pub. No.: US 2013/0136469 A1
(43) Pub. Date: May 30, 2013

(54) IMAGE FORMING APPARATUS

(71) Applicant: Canon Kabusihki Kaisha, Tokyo (JP)

(72) Inventor: Shigeru Tanaka, Tokyo (JP)

(73) Assignee: CANON KABUSHIKI KAISHA, Tokyo (JP)

(21) Appl. No.: 13/684,896

(22) Filed: Nov. 26, 2012

(30) Foreign Application Priority Data
Nov. 30, 2011 (JP) 2011-262594

(51) Int. Cl. G03G 15/00

(52) U.S. Cl. CPC G03G 15/0121; G03G 15/011
USPC 399/44; 399/49

(57) ABSTRACT

An image forming apparatus includes photoconductor drums, a plurality of development apparatuses, temperature-humidity sensors that detects at least temperatures or humidity of the development apparatuses, image density adjusting units that adjusts an image density of the toner image, and a control unit that adjusts the image density of the toner image by the image density adjusting units based on detection results of the temperature-humidity sensors. The control unit controls the adjusting unit based on information about color differences of detection values of the temperature-humidity sensors so that the adjusting unit adjusts an image density of the toner image or not.

### BACKGROUND OF THE INVENTION

1. Field of the Invention

The present invention relates to an image forming apparatus for forming a color image using a plurality of color toners.

2. Description of the Related Art

A conventional image forming apparatus controls a primary charger such that a bright region and a dark region are formed on a photoconductor drum using the primary charger and an exposure unit, the potentials thereof are detected, and the detection values thereof converge on a preset target value (Japanese Patent Laid-open No. 7-261480).

In addition, in another conventional image forming apparatus, a temperature-humidity sensor is installed at a development apparatus to recognize an environmental situation from moisture actually included in a developer. Then, highly precise feedback is performed and the developer is charged to a predetermined charging amount upon formation of an image, so that appropriate image formation is performed (Japanese Patent Laid-open No. 2007-65581).

Through an image forming condition adjusting operation such as potential control disclosed in Japanese Patent Laid-open No. 7-261480, a target value is generally set using an output signal of one temperature-humidity sensor. However, when the temperature-humidity sensor is installed at the development apparatus as disclosed in Japanese Patent Laid-open No. 2007-65581, four pieces of temperature-humidity information are input into a full color image forming apparatus. These conventional examples only disclose density changes of the respective single colors. Thus, when tendencies of the density changes are different depending on the respective single colors, the tendencies are recognized as a hue change of a secondary color formed of a plurality of color toners.

In order to solve this problem, detecting temperature-humidity information of four colors at a common timing of a predetermined time for a predetermined number of sheets, and performing the image forming condition adjusting operation based on these values may be considered. In addition, a method of performing an adjusting operation when variation in temperature-humidity information of each of the four temperature-humidity sensors exceeds a predetermined range may be considered.

However, in the above-mentioned method, the image forming condition adjusting operation is frequently performed, and productivity is decreased.

### SUMMARY OF THE INVENTION

Accordingly, it is desirable to provide an image forming apparatus capable of performing an efficient adjusting operation while having hue stability and maintaining productivity.

In order to accomplish the above-mentioned aspect, the present invention provides an image forming apparatus including: a plurality of development apparatuses that develops an electrostatic latent image to form a toner image of a chromatic color; atmosphere sensors that detect at least a temperature or humidity of each of the development apparatuses; an adjusting apparatus that adjusts an image density of the toner image; and a controller that controls the adjusting apparatus based on information about color differences of detection values of the atmosphere sensors so that the adjusting apparatus adjusts an image density of the toner image or not.

Further features of the present invention will become apparent from the following description of exemplary embodiments with reference to the attached drawings.

### BRIEF DESCRIPTION OF THE DRAWINGS

FIG. 1 is a configuration view of an image forming apparatus according to a first embodiment;

FIG. 2 is a block diagram illustrating a system configuration of the image forming apparatus of the first embodiment;

FIG. 3 is a configuration view of a temperature-humidity sensor of the first embodiment;

FIG. 4A is a view illustrating a relation between a charging bias and a photoconductor drum surface potential, and FIG. 4B is a table illustrating correspondences among relative humidity, Vcont, and Vback;

FIG. 5 is a flowchart for describing potential control of the first embodiment;

FIG. 6 is a flowchart for describing an operation of the image forming apparatus of the first embodiment;

FIG. 7 is a configuration view of a patch sensor of a second embodiment;

FIG. 8 is a block diagram illustrating a system configuration of an image forming apparatus according to the second embodiment;

FIG. 9 is a flowchart for describing gradation control of the second embodiment; and

FIG. 10 is a flowchart for describing an operation of the image forming apparatus of the second embodiment.

### DESCRIPTION OF THE EMBODIMENTS

### First Embodiment

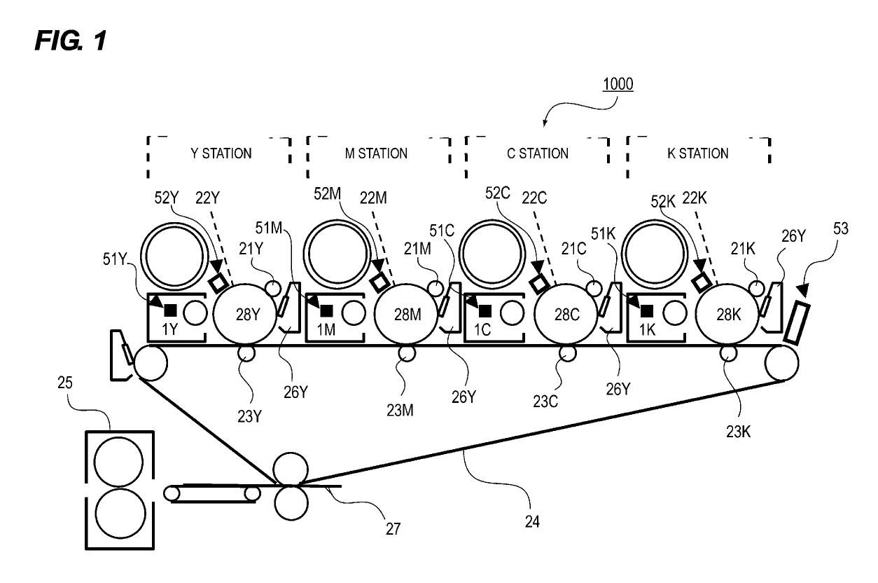

A first embodiment of an image forming apparatus according to the present invention will be described with reference to the accompanying drawings. FIG. 1 is a configuration view of an image forming apparatus 1000 according to the embodiment. As illustrated in FIG. 1, the image forming apparatus 1000 of the embodiment has respective stations of yellow, magenta, cyan, and black. In each of the stations, a charging bias in which an alternating current element overlaps a direct current element Vchg (V) is applied to primary chargers (image density adjusting apparatuses) 21Y to 21K from charging bias power supplies 41Y to 41K. Accordingly, surfaces of photoconductor drums (image bearing members) 28Y to 28K are charged with a white background portion potential Vd (V) by the primary chargers 21Y to 21K. In such an “AC charging type”, an alternating current element is adjusted such that a Vchg (V) value substantially becomes a Vd (V).

Then, electricity is removed through exposure by lasers 22Y to 22K based on image information, and an electrostatic latent image is formed on the photoconductor drum 28. The maximum density portion potential V1 (V) is formed twice as much as the maximum exposure is performed. The electrostatic latent image is developed as a chromatic color toner image using the respective color toners by a plurality of development apparatus 1Y to 1K. A developing bias in which an alternating current element overlaps a direct current element is applied to the development apparatuses 1Y to 1K from developing bias power supplies (image density adjusting apparatuses) 42Y to 42K.

The respective color toner images overlap and are transferred to an intermediate transfer belt 24 to be transferred to a sheet 27 by primary charging rollers 23Y to 23K. The sheet 27 to which the toner image is transferred is heated and pressed by a fuser 25 to fix the toner image. In addition, a residual toner remaining on the photoconductor drum 28 after the transfer is removed by cleaners 26Y to 26K.

(Temperature-Humidity Sensor 51, Electric Potential Sensor 52) Temperature-humidity sensors (atmosphere sensors) 51Y to 51K are disposed in the development apparatuses 1Y to 1K. The temperature-humidity sensors 51Y to 51K detect temperatures and humidity in the development apparatuses 1Y to 1K. Electric potential sensors 52Y to 52K are disposed between the lasers 22Y to 22K and the development apparatuses 1Y to 1K. The electric potential sensors 52Y to 52K detect surface potentials of the photoconductor drums 28Y to 28K.

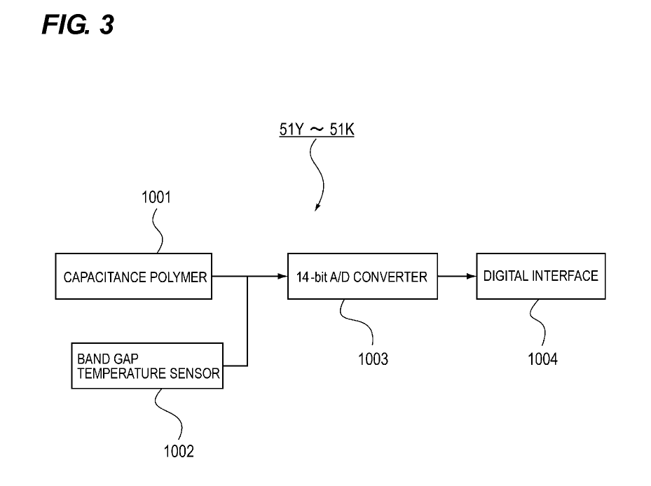

In the embodiment, a temperature-humidity sensor SHT1X series made by SENSIRION is used as the temperature-humidity sensors 51Y to 51K. As illustrated in FIG. 3, each of the temperature-humidity sensors 51Y to 51K has a sensing device 1001 of a capacitance polymer as a humidity detection device, and a band gap temperature sensor 1002 as a temperature detection device. The sensing device 1001 and the band gap temperature sensor 1002 are also CMOS devices coupled to a 14-bit A/D converter 1003 and configured to perform serial output through a digital interface 1004.

The band gap temperature sensor 1002 calculates a temperature from a resistance value thereof using a thermistor in which the resistance value is linearly varied with respect to the temperature. In addition, the sensing device 1001 is a capacitor into which a polymer is inserted as a dielectric, and detects the humidity through conversion of a capacitance into humidity using linear variation of the capacitance of the capacitor with respect to the humidity as a result of a moisture amount adsorbed by the polymer varying according to the humidity.

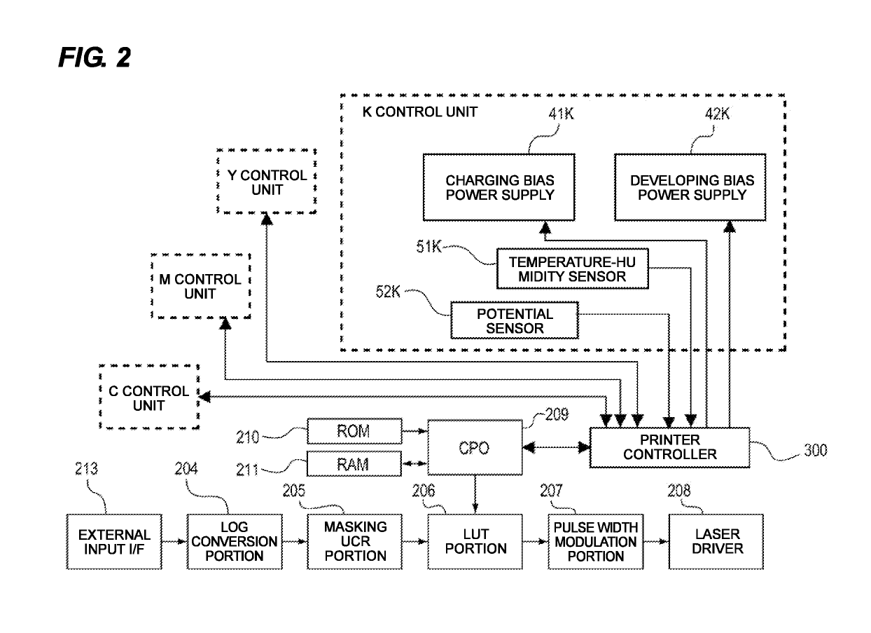

(System Configuration of Image Forming Apparatus 1000) FIG. 2 is a block diagram illustrating a system configuration of the image forming apparatus 1000 of FIG. 1. As illustrated in FIG. 2, the image forming apparatus 1000 inputs color image data as RGB image data from an external apparatus (not illustrated) such as an original scanner and a computer (an information processing apparatus) according to necessity via an external input interface (an external input I/F) 213.

Then, brightness data of the input RGB image data is converted into density data (CMY image data) of CMY based on γLUT (a lookup table) configured by data stored in a LOG converter 204, a ROM 210, or the like. A masking/UCR portion 205 performs matrix calculation on the CMKY image data, extracts black (Bk) element data from the CMY image data, and compensates for color turbidity of a record color material. A LUT portion 206 performs density compensation on each color of the input CMYK image data using the γLUT, and modifies the image data into ideal gradation characteristics of a printer portion. In addition, the γLUT is created based on data spread on a RAM 211, and the table contents thereof are set by a CPU 209.

A pulse width modulation portion 207 outputs a pulse signal having a pulse width corresponding to a level of image data (an image signal) input from the LUT portion 206. A laser driver 102 drives a laser 22 based on the pulse signal, and an electrostatic latent image is formed by irradiating the photoconductor drum 28 with the laser 22.

A printer controller 300 receives detection results of the temperature-humidity sensor 51 and the electric potential sensor 52, and controls image forming operations of the charging bias power supply 41, the developing bias power supply 42, and the like. A system configuration of the above-mentioned printer controller 300 and the like constitutes a control unit.

(Potential Control) The potential control includes performing common operations of the respective color stations concurrently. Here, an operation of one station will be described and the description of operations of the other stations will be omitted.

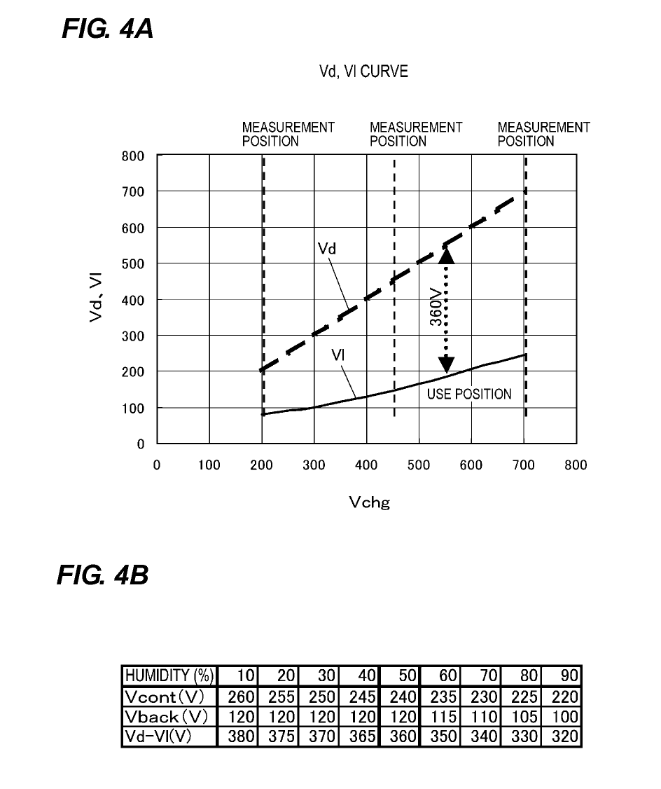

In FIG. 4A, the values of the white background portion potential Vd (V) and the maximum density portion potential V1 (V) are schematically illustrated when the direct current element Vchg (V) of the charging bias is varied. In addition, in FIG. 4A, while the potential is illustrated as a positive value, all actual values are negative potentials. The values of Vchg and Vd are substantially the same.

Here, as the laser 22 is driven with a pulse signal having the maximum level 255 among pulse signals having 256 gradations of levels 0 to 255 and the photoconductor drum 28 is exposed, a surface potential of the photoconductor drum becomes V1. As illustrated in FIG. 4A, while the value V1 is increased as Vchg (≈Vd) is increased, a difference between Vd and V1 is also increased.

FIG. 4B illustrates a latent image condition required according to a relative humidity (%) of the developer. Vcont is a difference between a direct current element Vdev of the developing bias and the maximum density portion potential V1. Vback is a difference between the direct current element Vdev of the developing bias and the white background portion potential Vd.

As illustrated in FIG. 4B, the value of Vcont is varied to obtain a desired image density according to the relative humidity of the developer. The value of Vback is varied to an optimal value such that toner fog of the white background portion of the image and attachment of a magnetic carrier do not occur according to the relative humidity of the developer. Then, because Vcont+Vback=Vd−V1, Vd−V1 to be set according to the relative humidity of the developer is varied.

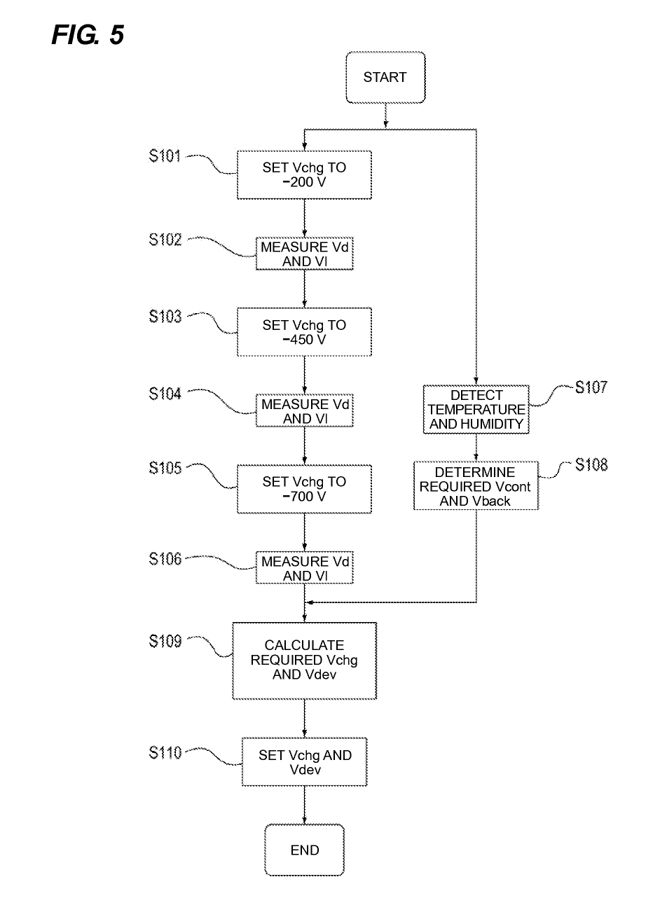

Here, the potential control when the relative humidity of the developer is 50% will be described. FIG. 5 is a flowchart for describing the potential control of the embodiment. As illustrated in FIG. 5, first, the printer controller 300 sets the direct current element Vchg of the charging bias to −200 V (S101).

Here, the white background portion potential Vd of a portion at which the pulse signal of the laser 22 is exposed as level 0 is measured using the electric potential sensor 52. In addition, the maximum density portion potential V1 at which the pulse signal is exposed as the level 255 is measured (S102). Then, the direct current element Vchg of the charging bias is set to −450 V and −700 V, and Vd and V1 values are similarly measured (S103 to S106).

In addition, concurrently with S101 to S106, the printer controller 300 detects the relative humidity value of the developer from the temperature-humidity sensor 51 (S107), and determines Vcont and Vback values based on the detection result with reference to FIG. 4B (S108). Here, since the relative humidity is 50%, Vcont and Vback are determined as 240 V and 120 V, respectively. That is, a required value of Vd−V1 is 360 V.

Next, the printer controller 300 obtains Vchg from three sets of Vd and V1 values measured in S101 to S106 such that the equation Vd−V1=360 V is satisfied, and calculates Vdev as a value obtained by subtracting Vback from this value (S109). The printer controller 300 sets Vchg and Vdev calculated as described above with respect to the charging bias power supply 41 and the developing bias power supply 42 (S110).

(Timing of Conventional Potential Control) In Patent Document 1 (Japanese Patent Laid-open No. 7-261480), when continuous image formation of 999 sheets is performed, potential control as illustrated in FIG. 5 is performed for every 100 sheets, for example, between 100th and 101st sheets and between 200th and 201st sheets.

As a surface potential of the photoconductor drum 28 is controlled by such potential control, an image density becomes exact and is stabilized. However, as the conventional image formation is stopped while the potential control is performed, productivity is decreased.

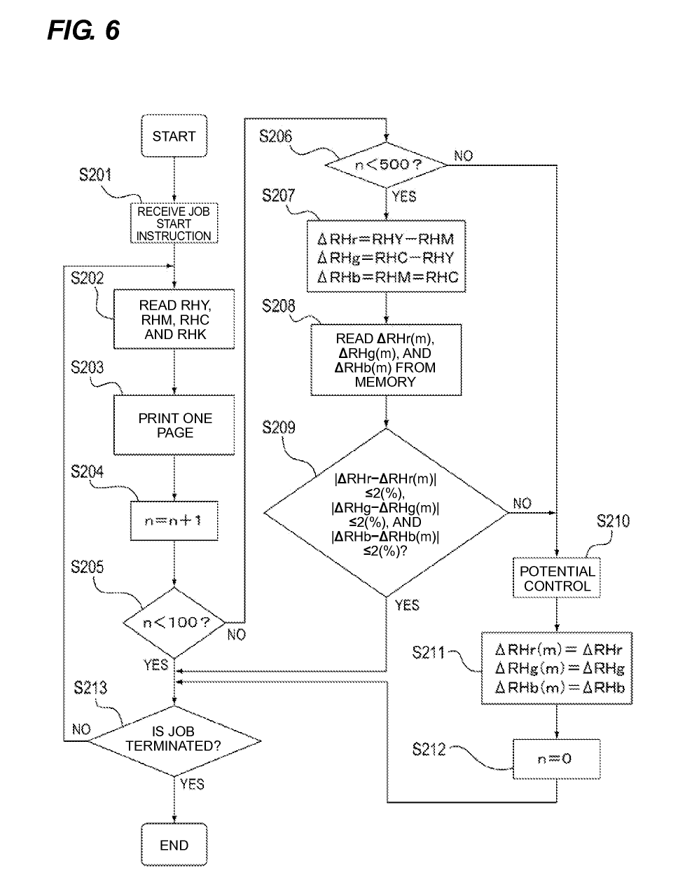

(Timing of Potential Control of Embodiment) FIG. 6 is a flowchart of an image forming operation and potential control of the image forming apparatus of the embodiment. As illustrated in FIG. 6, when the printer controller 300 receives a job start instruction (S201), the printer controller 300 reads humidity information RH (RHY, RHM, RHC, RHK) from the temperature-humidity sensors 51 of the respective stations (S202). Next, a print operation of one page is performed (S203), and a counter variable (a count value) n in the printer controller (a count unit) 300 is increased by one (S204). Then, it is determined whether n is less than 100 (less than the number of sheets of the first image formation) (S205).

When n is less than 100 in S205, it is determined that the job is terminated (S213). When the job is terminated, the image forming operation is terminated. When the job is not terminated, the control returns to S202, and a print operation of the next page is performed.

When n is 100 or more in S205 (the number of sheets of the first image formation or more), it is further determined whether n is less than 500 (less than the number of sheets of the second image formation) (S206). When n is 500 or more (the number of sheets of the second image formation or more) in S206, the potential control of FIG. 5 is performed by force (S210). Then, values of ΔRHr, ΔRHg, and ΔRHb (to be described later) are calculated to be stored on a memory of the printer controller 300 as ΔRHr(m), ΔRHg(m), and ΔRHb(m), respectively (S211). Then, the counter variable n is reset to 0 (S212), and the control returns to S213.

When n is less than 500 in S206, color differences of the humidity information RH (RHY, RHM, RHC) detected by the temperature-humidity sensors 51 of the development apparatuses 1Y to 1C of the chromatic colors are calculated (S207). Here, the color differences of the humidity information RH are displayed as ΔRHr=RHY−RHM, ΔRHg=RHC−RHY, and ΔRHb=RHM−RHC.

Then, calculation values ΔRHr(m), ΔRHg(m), and ΔRHb(m) of the last time of the color differences of the humidity information RH stored in the memory of the printer controller 300 are read (S208). Then, differences (variation amounts of the color differences) between ΔRHr, ΔRHg, and ΔRHb calculated at this time and ΔRHr(m), ΔRHg(m), and ΔRHb(m), which are stored values, are obtained. Then, it is determined that all of the absolute values of the three variation amounts of the color differences are a first predetermined value or less (2% or less in the embodiment) (S209). That is, it is determined whether |ΔRHr−ΔRHr (m)|≦2%, |ΔRHg−ΔRHg(m)|≦2%, or |ΔRHb−ΔRHb (m)|≦2%.

Here, when all vertical variation directions of the relative humidity of three colors Y, M and C are set, all of the image densities of the three colors Y, M and C move in the same direction. At this time, in red, green and blue, which are secondary colors formed by Y, M and C, a color change is reduced and is hardly perceived with the naked eye (variation in an H direction is small in an L*C*H color system).

Thus, when it is determined that all of the absolute values of the variation amounts of the color differences are 2% or less in S209, there is no need to compensate the image density by the potential control (S210), and the control skips S210 to S212 to return to S213. On the other hand, when it is determined that all of the absolute values of the variation amounts of the color differences are larger than 2% in S209, in the secondary colors, the color change is increased and is easily perceived with the naked eye. Thus, after S210 to S212 are performed and the image density is compensated, the control returns to S213.

Accordingly, when it is determined that there is no color change, stoppage of the image forming operation is not required and a decrease in productivity can be suppressed by omitting the potential control. Meanwhile, when it is determined that there is a color change, the potential control is performed to adjust the image density, and the image quality can be maintained. Therefore, the adjusting operation can be efficiently performed while having hue stability and maintaining productivity.

In addition, while omitted in the embodiment, the potential control can be performed when RHY, RHM, RHC, or RHK are varied to a certain extent or more.

### Second Embodiment

Next, a second embodiment of an image forming apparatus according to the present invention will be described with reference to the accompanying drawings. Components overlapping the description of the first embodiment are designated by the same reference numerals, and the description thereof will be omitted.

The image forming apparatus of the embodiment performs gradation control, unlike the potential control of the image forming apparatus of the first embodiment. In addition, it is determined whether the gradation control is performed by force based on the humidity information RH, unlike the counter variable n of the first embodiment. Vchg of each of the stations of the image forming apparatus of the embodiment is −600 V, and Vdev is −450 V. Vd is −600 V, and V1 is −200 V.

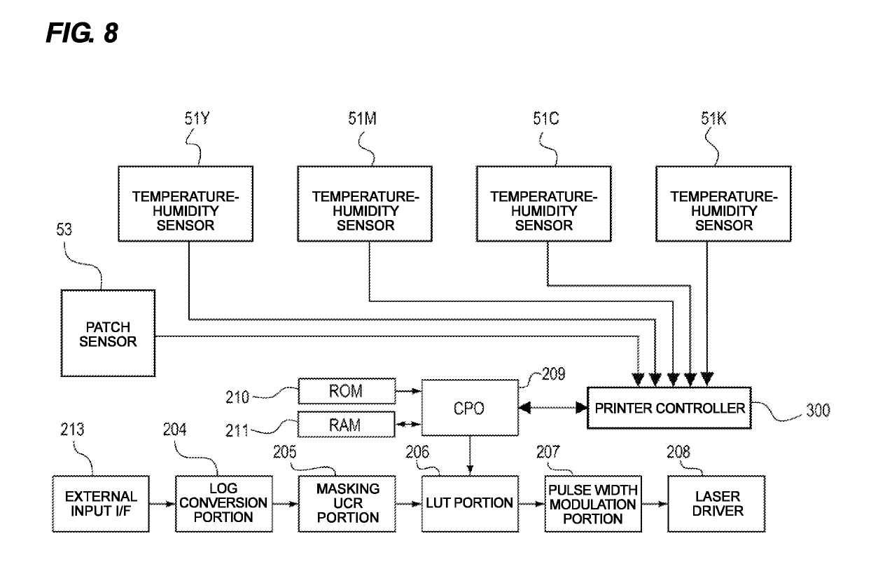

FIG. 8 is a block diagram illustrating a system configuration of the image forming apparatus 1000 of the embodiment. As illustrated in FIG. 8, the printer controller 300 receives detection results of the temperature-humidity sensor 51 and a patch sensor (a density detection unit) 53, and controls an image forming operation.

A reflection light quantity of a standard toner image exposed at a standard data level is detected by the patch sensor 53, an image density is detected, and stabilization of the image density is performed by the gradation control of drafting optimal γLUT (a gamma lookup table). γLUT is a table for determining a relation between 256 input levels and 256 output levels, and indicates whether outputs of the image forming apparatus reach a desired density gradation when laser exposure is performed at a pulse width of a certain level with respect to the input image signal.

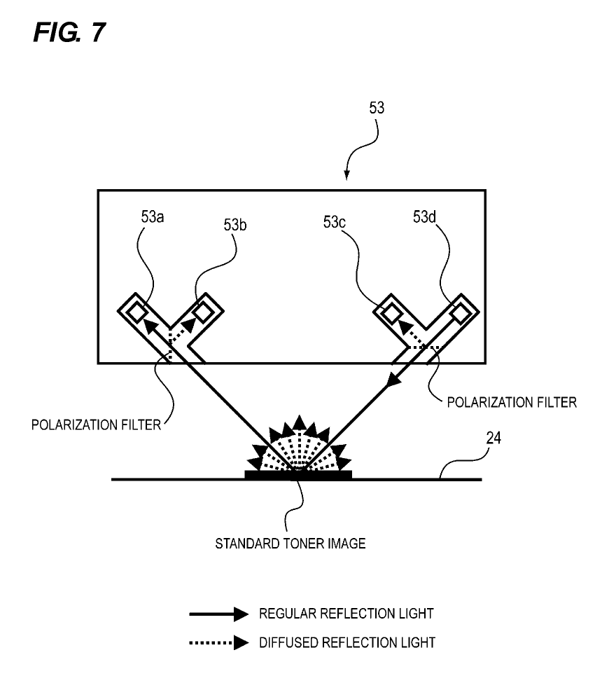

As illustrated in FIG. 1, the patch sensor 53 is disposed to oppose the intermediate transfer belt 24. FIG. 7 is a configuration view of the patch sensor 53. As illustrated in FIG. 7, the patch sensor 53 irradiates light having a wavelength of 670 nm from an LED 53d to a standard toner image transferred onto the intermediate transfer belt 24, and measures and compares the reflection light quantities by light receiving devices 53a, 53b and 53c to detect a toner attachment amount of the toner image.

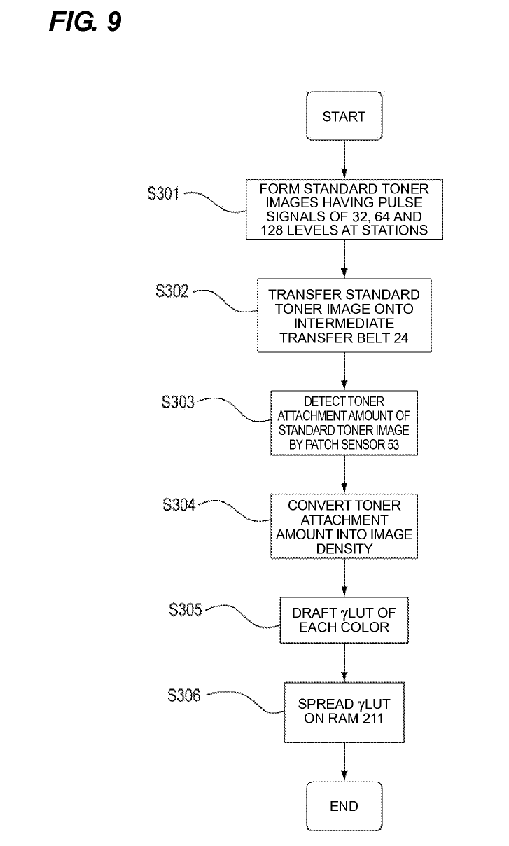

(Gradation Control) FIG. 9 is a flowchart of the gradation control of the image forming apparatus of the embodiment. As illustrated in FIG. 9, first, in each of the stations, standard latent images are formed such that pulse signals for driving the laser 22 are of 32 levels, 64 levels, and 128 levels and are developed to form a standard toner image (S301). Next, the standard toner image is transferred to the intermediate transfer belt 24 (S302) and conveyed to an opposite position of the patch sensor 53 to detect a toner attachment amount (S303). The standard toner images of the respective colors are timing-adjusted not to overlap each other.

The detected toner attachment amount is converted into the image density by the table previously inspected and stored in the printer controller 300 (S304). Accordingly, since the image densities having pulse signals corresponding to 32 levels, 64 levels, and 128 levels are respectively obtained, γLUT is drafted such that image data of CMYK and image densities linearly correspond to each other (S305). The drafted γLUT is spread on the RAM 211 (S306) and used upon the print operation.

An operation of a main body as described above is generally performed by the printer controller 300. A CPU in the printer controller 300 cooperates with a CPU 209 of an image processing unit side through an interface.

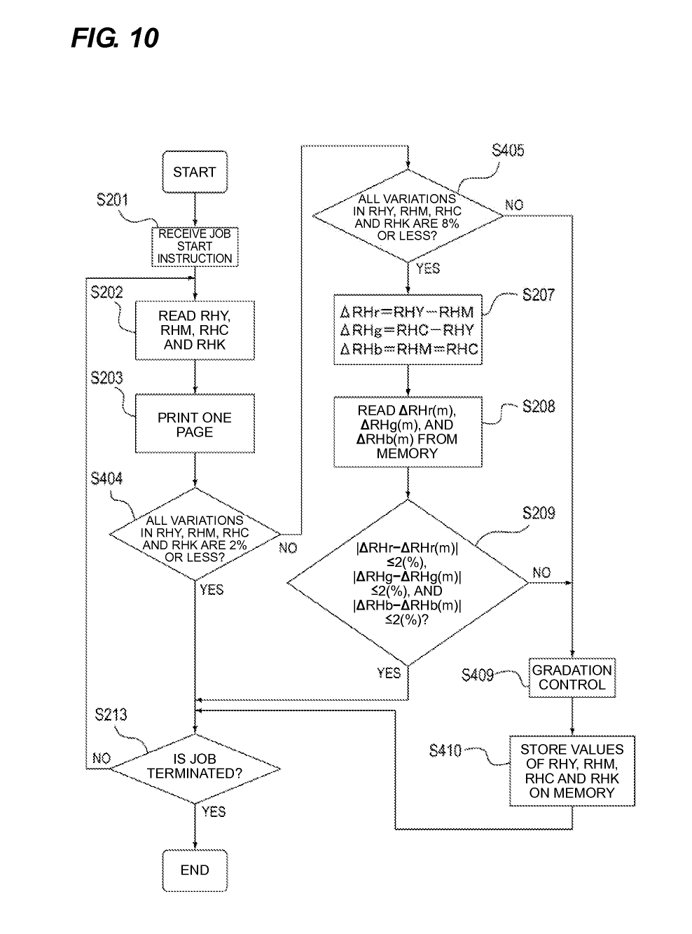

As the γLUT is drafted by the gradation control, the density becomes accurate and stable. However, conventional image formation is stopped while the gradation control is performed, and productivity is decreased. Here, in the embodiment, the gradation control is performed at a timing illustrated in FIG. 10, and a decrease in productivity is suppressed.

FIG. 10 is a flowchart of the image forming operation and gradation control of the image forming apparatus of the embodiment. As illustrated in FIG. 10, when the printer controller 300 receives a job start instruction (S201), the printer controller 300 first reads the humidity information RH (RHY, RHM, RHC, RHK) from the temperature-humidity sensors 51 of the respective stations (S202). Then, the print operation of one page is performed (S203).

After that, the last RHY to RHK values stored in the printer controller 300 are compared with RHY to RHK values read in S402, respectively, and it is determined whether all of the variation amounts are 2% or less (a second predetermined value or less) (S404).

When a value of 2% or less is determined in S405, it is determined that the probability of density variation is low, and then it is determined whether the job is terminated (S213). In S213, when it is determined that the job is terminated, the image forming operation is terminated. In S213, when it is determined that the job is not terminated, the control returns to S402, and the print operation of the next page is performed.

When a value of more than 2% (larger than a second predetermined value) is determined in S404, it is determined that there is the probability of density variation, and further, it is determined whether all of the variation amounts of RHY, RHM, RHC and RHK are 8% or less (a third predetermined value or less) (S405). When a value of more than 8% (larger than the second predetermined value) is determined in S405, it is determined that the probability of density variation is large, and the gradation control of FIG. 9 is performed by force (S409). Then, RHY, RHM, RHC and RHK read in S402 are stored in the memory of the printer controller 300 (S410), and the control returns to S213.

When a value of more than 8% is determined in S405, S207 to S209 of the first embodiment are performed. When it is determined that all absolute values of the variation amounts of the color differences are 2% or less in S209, there is no need to compensate the image density through the gradation control (S409), and the control skips S409 and S410 to return to S213. On the other hand, when it is determined that all of the absolute values of the variation amounts of the color differences are larger than 2% in S209, color change in the secondary color increases and is easily perceived with the naked eye. Thus, after S409 and S410 are performed and the image density is compensated, the control returns to S213.

Accordingly, when it is determined that there is no color change, there is no need to stop the image forming operation and the decrease in productivity can be suppressed by omitting the gradation control. Meanwhile, when it is determined that there is a color change, the gradation control can be performed to adjust the image density and maintain the image quality. Accordingly, the adjusting operation can be efficiently performed while having hue stability and maintaining productivity.

In addition, while omitted in the embodiment, the gradation control can be performed when RHY, RHM, RHC or RHK are varied to a certain extent or more.

While the present invention has been described based on the two embodiments, various aspects may be made within the spirit of the present invention. For example, a place at which the determination and control are performed with the relative humidity in the embodiments may be determined and controlled to be related to two detection values of the temperature and relative humidity using an absolute moisture amount. In addition, while not disclosed in the embodiment, the determination and control may be performed with respect to the detection result of black.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2011-262594, filed Nov. 30, 2011, which is hereby incorporated by reference herein in its entirety.

What is claimed is:

1. An image forming apparatus comprising:
a plurality of development apparatuses that develops an electrostatic latent image to form a toner image of a chromatic color;
atmosphere sensors that detect at least a temperature or humidity of each of the development apparatuses;
an adjusting apparatus that adjusts an image density of the toner image; and
a controller that controls the adjusting apparatus based on information about color differences of detection values of the atmosphere sensors so that the adjusting apparatus adjusts an image density of the toner image or not.

2. The image forming apparatus according to claim 1, the controller performs at least a mode in which the image density of the toner image is adjusted by the adjusting apparatus when at least one of variation amounts of color differences of detection values of the atmosphere sensors is larger than a first predetermined value based on detection results of the atmosphere sensors,
and the image density of the toner image is not adjusted by the adjusting apparatus when all of the variation amounts of color differences of the detection values of the atmosphere sensors are the first predetermined value or less based on the detection results of the atmosphere sensors.

3. The image forming apparatus according to claim 1 further comprising a counter that counts the number of image formation sheets,
wherein the controller does not adjust the image density of the toner image by the adjusting apparatus when a count value of the counter counted after the last adjustment of the image density is less than the number of first image formation sheets,
adjusts the image density of the toner image by the adjusting apparatus when the count value of the counter counted after the last adjustment of the image density is the number of second image formation sheets or more, which is the number of the first image formation sheets or more, and
performs the mode when the count value of the counter counted after the last adjustment of the image density is the number of the first image formation sheets or more and when the count value is less than the number of the second image formation sheets.

4. The image forming apparatus according to claim 1, wherein the controller does not adjust the image density of the toner image by the adjusting apparatus when all of the detection values of the atmosphere sensors are a second predetermined value or less,
adjusts the image density of the toner image by the adjusting apparatus when one of the detection values of the atmosphere sensors is larger than a third predetermined value, which is larger than the second predetermined value, and
performs the mode when one of the detection values of the atmosphere sensors is larger than the second predetermined value and when all of the detection values of the atmosphere sensors are the third predetermined value or less.

5. The image forming apparatus according to claim 1, wherein the adjusting apparatus controls a charging bias that charges to form a latent image and a developing bias that develops a toner image, and adjusts the image density of the toner image.

6. The image forming apparatus according to claim 1 further comprising:
an exposure apparatus that exposes a laser to form an electrostatic latent image; and
a density sensor that detects the image density of the toner image,
wherein the adjusting apparatus drafts a lookup table in which a relation between strength and image density of the laser of the exposure apparatus is determined based on the image density detected by the density sensor, and adjusts the image density of the toner image.
